(19) United States
(12) Patent Application Publication
(10) Pub. No.: US 2026/0187206 A1
(43) Pub. Date: Jul. 2, 2026

(54) METHOD AND APPARATUS FOR WATERMARK EMBEDDING IN FREQUENCY DOMAIN USING CONCENTRIC PATTERN INFORMATION

(71) Applicant: MARKANY INC., Seoul (KR)

(72) Inventor: Byung Seok MIN, Seoul (KR)

(73) Assignee: MARKANY INC., Seoul (KR)

(21) Appl. No.: 19/412,864

(22) Filed: Dec. 9, 2025

(30) Foreign Application Priority Data
Dec. 30, 2024 (KR) 10-2024-0200529

(51) Int. Cl. G06F 21/16; G06T 5/80

(52) U.S. Cl. CPC G06F 21/16; G06T 5/80

(57) ABSTRACT

The present invention relates to a method and apparatus for embedding a watermark to hide information within digital media. More specifically, the present invention relates to a method and apparatus for embedding watermarks in the frequency domain and such apparatus therefor. A method for embedding a digital watermark into digital media according to one embodiment of the present invention may include: receiving digital media; generating a watermark message; generating a concentric pattern including multiple concentric orbits based on the watermark message; generating first frequency domain data including the concentric pattern; and embedding a watermark by merging the first frequency domain data with the digital media.

### CROSS REFERENCE TO RELATED APPLICATION

This application claims priority from Republic of Korea Patent Application No. 10-2024-0200529, filed on Dec. 30, 2024, which is hereby incorporated by reference in its entirety.

### FIELD OF INVENTION

The present invention relates to a method and apparatus for embedding a watermark to hide information within digital media. More specifically, the present invention relates to a method and apparatus for embedding watermarks in the frequency domain and such apparatus therefor.

### BACKGROUND

Recently, nearly every aspect of daily life and services—including office work, payment services, certificate issuance, banking, e-commerce, and the creation and provision of cultural media—has become reliant on online and computerized environments. In such online and computerized environments, digital media is used for generating, displaying, storing, editing, and transmitting information. As used herein, digital media refers to various forms of digital information including images, text, and multimedia; for example, digital documents, pictures, audio, video, and three-dimensional data.

However, due to the inherent characteristics of digital information, digital media can be easily replicated or transmitted without any loss of information, making it highly vulnerable to unauthorized disclosure, i.e., “leakage”. Therefore, to maintain a secure digital media environment, protection measures (i.e., security systems) are essential to guard digital media against illicit actions. For instance, digital media can be safeguarded through encryption and decryption systems, watermarking or fingerprinting systems, or screen capture prevention systems.

Digital watermarking is one such approach. Many commonly used digital watermarking techniques involve embedding predetermined auxiliary information in a digital media by applying a machine-readable manipulation at specified temporal or spatial locations. The embedded auxiliary information can subsequently be detected by devices or software configured to detect and interpret such manipulations, through analysis of the watermarked digital media.

The auxiliary information may indicate digital media ownership or indicate restrictions on copying or displaying. Such auxiliary information can be embedded in digital media through virtually imperceptible manipulations that human observers cannot recognize but are still machine-readable.

Additionally, forensic watermarking methods have recently been introduced, which use digital watermarking to embed traceability information as auxiliary information in videos prior to distribution to prevent potential leakage. By embedding recipient information of the digital media within the digital media itself before distribution, it becomes possible to identify individuals who have used digital media through unauthorized means or participated in the illegal leakage of digital media.

One of the prominent methods for embedding digital watermarks is using frequency domain-based embedding. Such conventional techniques involve applying transform functions such as Fourier transform or cosine transform to convert digital media from its general information form into frequency information, then embedding the watermark into the resulting frequency information, and finally performing an inverse transform to restore the original form.

Another prominent method for embedding digital watermarks is using pattern overlay mechanism. Such conventional techniques involve forming digital patterns according to predetermined rules and/or encryption methods, and overlaying these patterns onto the original digital media in an invisible form through various mathematical techniques by applying a predetermined transparency level.

While the fundamental principles of the aforementioned conventional techniques are conventionally known, deriving specific implementation methods remains a constant challenge due to the requirement to ensure sufficient robustness. Digital media cannot be guaranteed to always being distributed in the exactly same form it had when the watermark was initially embedded, and such digital media may be modified or corrupted during distribution and/or illegal leakage processes, either due to technical reasons or intentional manipulation. In particular, acts of damaging or distorting information to circumvent tracking by the aforementioned forensic watermarks, known as “attacks” on watermarks, can occur at any time. Therefore, appropriate technical implementation means are required that can embed the aforementioned frequency-based and/or pattern overlay-based watermarks in a manner sufficiently robust against such attacks while avoiding manipulations that would significantly damaging the value of the digital media.

### SUMMARY

The present invention seeks to provide a novel method robust against corruption of digital media in watermark methods embedded in the frequency domain, and an apparatus for implementing such methods. Specifically, the invention aims to provide a watermark method and apparatus that are robust against cropping and geometric transformation of original images as frequency-based watermarks applied to digital images.

To solve the aforementioned technical problem, a method for embedding a digital watermark into digital media according to one embodiment of the present invention comprises: receiving digital media; generating a watermark message; generating a concentric pattern including multiple concentric orbits based on the watermark message; generating first frequency domain data including the concentric pattern; and embedding a watermark by merging the first frequency domain data with the digital media.

The concentric pattern may be characterized as being formed by placing at least one blob on each of the concentric orbits.

The step of generating the concentric pattern may include configuring the concentric pattern by varying at least one characteristic among size and shape for at least one of the blobs included in the concentric pattern, in correspondence with symbols constituting the watermark message.

The step of generating the concentric pattern may be characterized by configuring the concentric pattern by associating multiple blobs included in the concentric pattern with each symbol constituting the watermark message.

The concentric pattern may be characterized as including error correction codes.

The concentric pattern may be characterized as being generated while avoiding low-frequency regions in the frequency domain.

The step of embedding the watermark may include: converting the digital media into second frequency domain data; merging the first frequency domain data with the second frequency domain data to generate third frequency domain data; and inverse transforming the third frequency domain data.

The step of embedding the watermark may be characterized as being performed limited to at least one channel among multiple channels when the digital media includes multiple channels.

The step of embedding the watermark may be characterized as being performed on multiple channels, with weights related to watermark embedding applied between the multiple channels.

To solve the aforementioned technical problem, a method for detecting a digital watermark from digital media according to one embodiment of the present invention comprises: receiving watermarked digital media; frequency transforming the watermarked digital media to obtain fourth frequency domain data; extracting a concentric pattern region from the fourth frequency domain data; correcting geometric distortion of the concentric pattern region; detecting the presence of a concentric pattern including multiple concentric orbital tracks in the concentric pattern region; and when the concentric pattern is detected, detecting a watermark message from the concentric pattern.

The step of extracting the concentric pattern region may be characterized as including removing low-frequency region data from the fourth frequency domain data.

The step of correcting geometric distortion may include applying at least one geometric correction among: correction of scaling distortion based on the radius size of the concentric pattern; correction of translation distortion based on the center point position of the concentric pattern; and correction of skew distortion based on the orbital shape of the concentric pattern.

The method may further include designating multiple detection target zones from the watermarked digital media, wherein the step of obtaining the fourth frequency domain data includes: performing frequency transformation on each of the multiple detection target zones to generate multiple fifth frequency domain data; and overlapping the multiple fifth frequency domain data to generate the fourth frequency domain data.

The step of detecting the watermark message from the concentric pattern may include: detecting error correction codes from the concentric pattern; and correcting errors in the watermark message using the error correction codes.

The concentric pattern may be characterized as being formed to include at least one blob on each of the concentric orbital tracks.

The step of detecting the watermark message may include recognizing symbols constituting the watermark message according to at least one characteristic among size and shape represented by at least one blob included in the concentric pattern.

The step of detecting the watermark message may be characterized by associating multiple blobs included in the concentric pattern with one symbol constituting the watermark message.

The step of detecting the presence of the concentric pattern may include confirming through pattern matching whether frequency domain information recognizable as blobs exists at positions corresponding to the insertion information, based on concentric pattern insertion information that places at least one blob at a designated position on at least one orbital track.

To solve the aforementioned technical problem, an apparatus for embedding a digital watermark into digital media according to one embodiment of the present invention comprises: an embedding source input unit for receiving digital media; an embedding message input unit for receiving a watermark message; a pattern generation unit for generating a concentric pattern including multiple concentric orbital tracks based on the watermark message; a first frequency transform unit for generating first frequency domain data including the concentric pattern; and a watermark embedding unit for embedding a watermark by merging the first frequency domain data with the digital media.

To solve the aforementioned technical problem, an apparatus for detecting a digital watermark from digital media according to one embodiment of the present invention comprises: a detection source input unit for receiving watermarked digital media; a second frequency transform unit for frequency transforming the watermarked digital media to obtain fourth frequency domain data; a pattern extraction unit for extracting a concentric pattern region from the fourth frequency domain data; a pattern correction unit for correcting geometric distortion of the concentric pattern region; a pattern identification unit for detecting the presence of a concentric pattern including multiple concentric orbital tracks in the concentric pattern region; and a watermark detection unit for detecting a watermark message from the concentric pattern when the concentric pattern is detected.

According to the present invention, a more effective and stable watermarking solution for copyright protection and traceability of digital media can be provided by embedding watermark information in the frequency domain using concentric patterns.

According to one embodiment of the present invention, a watermarking method and apparatus robust against geometric transformations can be provided by expressing watermark information using the size, shape, and position of blobs placed on concentric circles forming concentric patterns. In particular, even when geometric transformations such as rotation or scaling are applied, the structural characteristics of the concentric pattern enable stable detection of the original watermark information.

According to one embodiment of the present invention, each circular orbital track of the concentric pattern can be utilized independently, providing the advantage of embedding various types of information within a single watermark. For example, auxiliary information for error correction can be embedded in the outer circular orbital tracks, while key messages can be embedded in the inner circular orbital tracks, enabling differentiated information embedding according to purpose.

According to one embodiment of the present invention, the invention provides the advantage of being able to adjust the capacity and robustness of embedded watermarks by variously modifying the size, shape, and arrangement of blobs forming the concentric pattern. Additionally, watermarks can be embedded limited to selected channels among multiple color channels, enabling optimized watermarking according to the characteristics of the digital media.

### BRIEF DESCRIPTION OF THE DRAWINGS

FIG. 1 is a flowchart illustrating a method for embedding a digital watermark into digital media according to one embodiment of the present invention.

FIG. 2 is a first exemplary diagram of a concentric pattern according to one embodiment of the present invention.

FIG. 3 is an exemplary diagram of various implementation methods of a concentric pattern according to one embodiment of the present invention.

FIG. 4 is an exemplary diagram illustrating blob placement positions in a concentric pattern according to one embodiment of the present invention.

FIG. 5 is an exemplary diagram illustrating a method for expressing watermark messages using concentric patterns according to one embodiment of the present invention.

FIG. 6 is an exemplary diagram of symmetry limitation in concentric patterns according to one embodiment of the present invention.

FIG. 7 is a conceptual diagram of an implementation method for merging base patterns and concentric patterns in the frequency domain according to one embodiment of the present invention.

FIG. 8 is a conceptual diagram of a watermark embedding method in the frequency domain according to one embodiment of the present invention.

FIG. 9 is a conceptual diagram of another watermark embedding method in the frequency domain according to another embodiment of the present invention.

FIG. 10 is a flowchart illustrating a method for detecting a digital watermark from digital media according to one embodiment of the present invention.

FIG. 11 is a conceptual diagram illustrating a process for identifying concentric pattern regions through outlier detection according to one embodiment of the present invention.

FIG. 12 is an exemplary diagram illustrating a pattern matching process for blob identification in concentric patterns according to one embodiment of the present invention.

FIG. 13 is an exemplary diagram illustrating a method for expressing watermark messages through grouping of blobs according to one embodiment of the present invention.

FIG. 14 is a conceptual diagram of a watermark embedding and detection system comprising a digital watermark embedding apparatus and a digital watermark detection apparatus according to one embodiment of the present invention.

### DESCRIPTION OF EXEMPLARY EMBODIMENTS

The present invention is subject to various modifications and encompasses multiple embodiments. Specific embodiments are illustrated in the drawings and described in detail below. However, these are not intended to limit the invention to particular forms, and it will be understood that all modifications, equivalents, and substitutions falling within the spirit and scope of the present invention are intended to be covered.

The terms “first,” “second,” and the like may be used to describe multiple elements, but such elements should not be limited by these terms. The terminology is used solely for distinguishing one element from another. For example, within the scope of the present invention, a first element may be referred to as a second element and, likewise, a second element may be referred to as a first element without departing from the inventive concept. The term “and/or” is inclusive, meaning any combination or any of the listed items, unless clearly indicated otherwise.

When the present application enumerates items, those statements are intended to facilitate comprehension of the invention and illustrative manners of implementation, and are not intended to limit the scope of the embodiments of the present invention.

As used herein, the phrase “A or B” may mean “only A,” “only B,” or “both A and B.” In other words, “A or B” as used in this specification may be interpreted as “A and/or B.” For example, “A, B, or C” may mean “only A,” “only B,” “only C,” or “any combination of A, B, and C.”

When a slash (/) or a comma appears in this specification, it may mean “and/or.” For example, “A/B” may mean “A and/or B,” and accordingly may represent “only A,” “only B,” or “both A and B.” Similarly, “A, B, C” may mean “A, B, or C.”

The phrase “at least one of A and B” may mean “only A,” “only B,” or “both A and B.” Likewise, the expressions “at least one of A or B” and “at least one of A and/or B” may be interpreted in the same way as “at least one of A and B.”

Additionally, the phrase “at least one of A, B, and C” means “only A,” “only B,” “only C,” or “any combination of A, B, and C.” Similarly, the phrases “at least one of A, B, or C” and “at least one of A, B, and/or C” should be understood to have the same meaning as “at least one of A, B, and C.”

When a component is described as being “connected” or “coupled” to another component, it should be understood that the connection or coupling may be direct or via one or more intervening elements. Conversely, when a component is referred to as “directly connected” or “directly coupled,” it should be understood that there are no intervening elements between them.

The terminology used herein is for the purpose of describing particular embodiments only and is not intended to be limiting of the invention. As used herein, the singular forms are intended to include the plural forms as well, unless the context clearly indicates otherwise. Terms such as “include” or “have” or their variants specify the presence of stated features, steps, operations, components, or combinations thereof, but do not preclude the presence or addition of one or more other features, steps, operations, components, or combinations thereof.

Unless otherwise defined, all technical and scientific terms used herein have the same meaning as commonly understood by one of ordinary skill in the art to which this invention pertains. Terms that are defined in commonly used dictionaries should be interpreted as having a meaning that is consistent with their use in the context of the relevant technical field and are not to be interpreted in an idealized or overly formal sense unless expressly so defined herein.

The embodiments of the present invention may be described or illustrated in the form of functional blocks that perform one or more functions. These blocks may be implemented as one or more devices, units, modules, or components. The blocks may be implemented in hardware by means of one or more logic gates, integrated circuits, processors, controllers, memory, electronic components, or any information processing hardware. Conversely, the blocks may be implemented in software by application software, an operating system, firmware, or any information processing software. A functional block may be divided into multiple blocks performing the same function or, conversely, multiple blocks may be integrated into a single block performing the functions of those blocks. Blocks may also be physically separated or merged based on any desirable criteria. Furthermore, blocks may operate in a distributed environment where physical locations are not specified, such as over a communication network, the Internet, cloud services, or the like. All such implementations are within the technical scope of this invention and may be adopted by those skilled in the art to realize the invention.

Hereinafter, preferred embodiments of the present invention will be described in detail with reference to the accompanying drawings. To facilitate overall understanding, like reference numerals are used for the same or similar elements throughout the drawings, and redundant descriptions are omitted. Multiple embodiments are not mutually exclusive and, in some instances, may be combined with one or more other embodiments to create new embodiments.

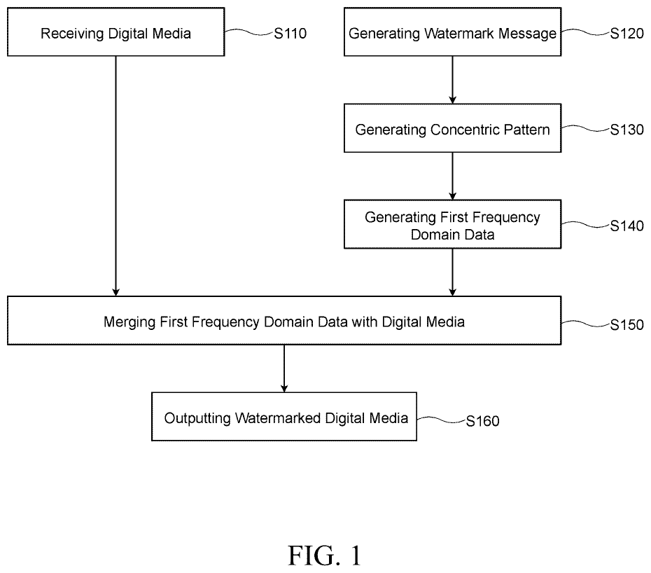

FIG. 1 is a flowchart illustrating a method for embedding a digital watermark into digital media according to one embodiment of the present invention. Referring to FIG. 1, the method according to one embodiment of the present invention may include: receiving digital media into which a watermark is to be embedded (S110); generating a watermark message (S120); generating a concentric pattern based on the message (S130); generating first frequency domain data including the concentric pattern (S140); embedding a watermark by merging the first frequency domain data with the digital media (S150); and outputting the watermarked digital media (S160).

The concentric pattern refers to a structure in which multiple blobs are arranged on one or more circular orbits based on a center point. The blobs may have various shapes such as circular, rectangular, or polygonal forms, and their sizes may be variable. According to one embodiment of the present invention, the circular orbits have different radii, and each orbit can be used to express independent information. According to one embodiment of the present invention, the circular orbits may each have radii with integer ratios. According to one embodiment of the present invention, the circular orbits may be configured to include the same number of blobs, thereby expressing multiple concentric radial lines, in which case the concentric pattern may be referred to as a radial line pattern. Also, according to one embodiment of the present invention, when nothing is placed in a space where a blob could be placed, it may be considered as placing a blob of size zero.

The step of receiving digital media into which a watermark is to be embedded (S110) may be configured to receive digital media via a digital communication network, read digital media stored on fixed or removable digital recording media, or read digital media generated in real-time from input equipment including video cameras or voice recorders. It is obvious that various other implementation methods for inputting digital media information can be applied.

According to a preferred embodiment of the present invention, the digital media may be a two-dimensional image, and this standard will be taken as a representative example for describing the present invention in this specification. However, those skilled in the art will understand that the present invention applicable to two-dimensional images can also be applied to any type of digital media information implemented by video (implemented as a combination of multiple still images), audio, three-dimensional images, holograms, and other digital signals, and therefore, it is obvious that such modified embodiments should also be considered as derivations of the present invention disclosed through this specification.

According to one embodiment of the present invention, only a portion of the digital media may be processed as a watermark embedding subject area. For example, when the digital media is an image, only some spatially divided regions of the image may be processed as watermark embedding subject areas. As another example, when the digital media is an image with color information, at least one piece of partial information representing the color information and/or at least one piece of channel information expressing the color information may be partially processed as the watermarking subject. In any case, watermarks may be embedded limited to selected partial sections/subjects among the multiple regions or channels. Various methods conventionally known in the art or newly provided may be used to separate such partial regions or channels in order to determine the watermarking subject area(s), and the details of such variations are not limited in the present invention.

According to one embodiment of the present invention, for example, in a digital media image using RGB (red, green, blue) color representation, only the R (red) channel may be the processing target for watermark information embedding. Also, according to embodiments, multiple color channels may be selected as processing targets, and in such cases, each channel may be utilized for watermark embedding with different weights. For example, when using the G (green) channel together with the R channel, watermarks may be embedded in both the R channel and G channel, but with different weights.

The present invention may be applied to digital media images composed of various channel information according to embodiments. For example, it is obvious that the invention can be applied in the same way when using HSB (hue, saturation, brightness) color representation, when using CMYK (cyan, magenta, yellow, black) color representation, when using luminance and chrominance-based color representations such as YUV/YCbCr, and when channel information is configured by various other color representations not mentioned above. According to embodiments, even when channels containing additional information additive to any color representation, such as transparency, alpha, and/or depth channel, the embodiment can be applied in the same way by including such additional channels. Also, according to embodiments, the digital media may be converted for the partial processing; for example, to facilitate watermark embedding process based on luminance channel information, the digital media may be converted from RGB color representation to color representation methods having luminance channels such as HSB or YUV. The details of such color conversion methods are not limited in the present invention.

In the present invention, the digital media may be considered as information requiring protection. In one embodiment of the present invention, the digital media may be information that, when distributed to the public, may be exposed to illegal use or distribution such as unauthorized copying. In this case, the present invention may be used to embed (i.e., hide) predetermined information in the form of a watermark prior to distribution of the digital media. Therefore, in the step of generating a watermark message (S120), the watermark message may be generated based on the predetermined information.

The predetermined information may include information for identifying content, information for traceability, and/or information for control. Specifically, the content identification information may include information related to the title, length, type, language, subtitles, copyright holder, distributor, supply channel, and viewing age restrictions of content included in the digital media.

Alternatively, the predetermined information may include information for maintaining security of the digital media. Specifically, it may include copy permission information, copy protection information, and traceability information. Alternatively, the predetermined information may include information for controlling devices that receive and view the digital media. Specifically, it may include metadata for additional services or terminal control commands that such devices can recognize as control signals.

The predetermined information may be traceability information that enables identification and distinction of digital media distributed to one viewing device as a copy of the digital media from other copies, such as digital media distributed to other viewing devices. The traceability information may include identification information related to the viewing device. Specific examples may include the type of device hardware of the viewing device, device hardware identifier (e.g., device UUID), device software identifier, device software version, or other information necessary for identifying the viewing device.

The traceability information may include at least one type of information related to means for distributing the digital media. The distribution means may use conventional wired/wireless digital communication networks, hard-wired wiring, or physical recording media including hard disks, optical media, and flash memory. Therefore, the traceability information may include the communication network address, network interface identifier, or network path information of the viewing device when the distribution means is a communication network; may include identification information of the wiring path when the distribution means is fixed wiring; and may include unique identifiers for identifying copies of specific physical recording media when the distribution means is physical recording media.

Also, the traceability information may include identification information related to users of the viewing device. Specific examples may include user identification information of the user (e.g., service user ID), personal identification information (e.g., name, identity credentials, etc.), details of payments by the user to access the digital media, financial transaction information performed by the user for the payments, or other information for ultimately identifying the user.

In the step of generating a watermark message (S120), the watermark message may mean processing the predetermined information into a form suitable for embedding as a watermark.

In one embodiment of the present invention, the message may consist of multiple embedding symbols. The embedding symbols may be selected from a set of at least two types of distinguishable identification symbols. Also, the embedding symbols may be numbers having a base of 2 or more. In this case, the message may be the result of encoding the predetermined information appearing in human-interpretable form according to the symbol composition method of the embedding symbols. For example, when the embedding symbols are binary digital information symbols that can have values of 0 or 1, the letter “A” may be converted to decimal number 65 by ASCII encoding, then converted again to binary number 1000001, thereby constituting a watermark message represented by at least 7 embedding symbols. It can be easily understood that various techniques applicable by those skilled in the art can be utilized for information encoding methods and types and bases of embedding symbols, and the possibility of such variation does not limit the technical scope of the present invention.

The step of generating a concentric pattern based on the message (S130) may, according to one embodiment of the present invention, be configured as a step of encoding the message based on multiple concentric orbits in a pattern having concentric characteristics.

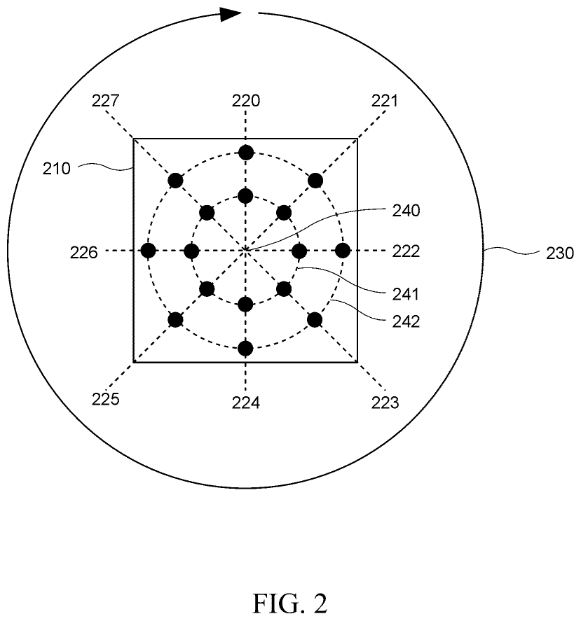

FIG. 2 is a first exemplary diagram of a concentric pattern according to one embodiment of the present invention. Referring to FIG. 2, concentric pattern 210 includes multiple concentric circles 241, 242 based on center point 240, and multiple blob insertion points 220-227 may be arranged on each concentric circle.

According to one embodiment of the present invention, the multiple concentric circles may be distinguished by their radius, which is the distance from center point 240. According to the example in FIG. 2, the case of using two concentric circles is shown, where first concentric circle 241 has a radius of a first length, and second concentric circle 242 may have a radius corresponding to twice the first length. As such, the multiple concentric circles may be configured to have radii in integer ratios to each other. Also, multiple blob insertion points may be formed on each concentric circle, and the points may preferably be equally spaced. According to the example in FIG. 2, blob insertion points 220-227 arranged at equal intervals may be formed for each concentric circle. The example in FIG. 2 shows one embodiment where 8 blob insertion points are arranged on each concentric circle 241, 242, with each point arranged at 45-degree intervals. However, the example shown in FIG. 2 should be understood as an arbitrary arrangement to aid understanding of the present invention, and for instance, the concentric circles may not have integer ratio relationships with each other, the points may not be equally spaced, and the separation angle of the points need not be 45 degrees, and it is obvious that various modifications are possible within the technical concept of the present invention.

In concentric pattern 210, the blob insertion points may be used to express certain message information. The message information may be read according to a predetermined order 230, and the order may follow a clockwise or counterclockwise rotation sequence. According to one embodiment of the present invention, the order may start at any angle, and according to embodiments, the order may be arbitrarily rearranged. According to embodiments, the blob insertion points may be configured to express messages based on each angle, express messages based on each concentric circle, or express messages in a mixed form of each. According to embodiments, the multiple concentric circles may independently express different information using their blob insertion points. For example, blob insertion points arranged on first concentric circle 241 and second concentric circle 242 may be configured to include different types of messages. According to another embodiment, the same message may be redundantly expressed on multiple concentric circles, thereby improving message detection accuracy. According to yet another embodiment, at least one of the multiple concentric circles may be configured to express meta information about the message information, for example, error correction code (ECC).

According to one embodiment of the present invention, various types of blobs may be expressed at the blob insertion points. For example, the blobs may have various shapes including circular, elliptical, rectangular, polygonal, and other figures, and their sizes may be variable. Also, two or more of the various shapes may be used in combination. Also, even when nothing is placed in a space where a blob could be placed, this may be considered as placing a blob of size zero, so in describing various principles and implementation methods of the present invention, leaving empty areas where blobs could be placed should be understood as substantially equivalent to inserting identifiable blobs. According to one embodiment of the present invention, by configuring different shapes or sizes used to express each blob, each blob can be interpreted as a specific signal.

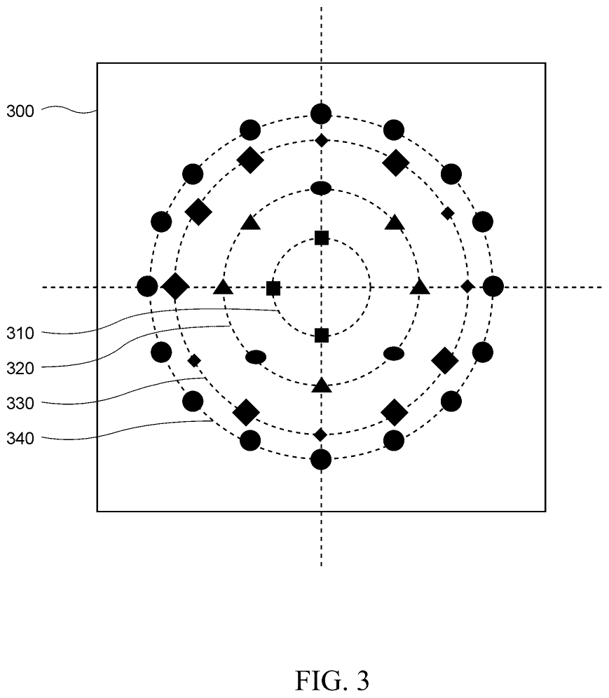

FIG. 3 is an exemplary diagram of various implementation methods of a concentric pattern according to one embodiment of the present invention. Example 300 of FIG. 3 comprehensively shows that concentric patterns according to the present invention can be implemented in various forms.

According to embodiments, concentric pattern 300 may include multiple concentric circles having different radii, for example concentric circles 310, 320, 330, 340. At this time, it is exemplified that the radii of the multiple concentric circles may have integer or non-integer ratios. For example, in the example of FIG. 3, when the radius of first concentric circle 310 is 1, second concentric circle 320 may have a radius of 2 times, third concentric circle 330 may have a radius of 3 times, and fourth concentric circle 340 may have a radius of 3.5 times.

According to embodiments, each concentric circle may express different amounts of information. For example, in the example of FIG. 3, the innermost first concentric circle 310 may express 4 bits, second concentric circle 320 may express 8 bits, third concentric circle 330 may express 12 bits, and fourth concentric circle 340 may express 16 bits of information. The number of bits need not be in multiples of each other and may be independently determined according to the purpose of each concentric circle. Also, the starting point for reading the bits may be designated in any direction. For example, various applications are possible such as reading clockwise along the concentric circle from the vertical (12 o'clock) direction, or reading counterclockwise by angle from the left (9 o'clock) direction.

According to embodiments, each concentric circle may express information using blobs of different shapes. For example, in the example of FIG. 3, first concentric circle 310 expresses signals by the presence or absence of rectangular blobs, representing 4-bit information “1011” starting from the vertical (12 o'clock) direction. Second concentric circle 320 uses triangular or elliptical blobs to express 8-bit information “1101 1010” starting from the left (9 o'clock) direction. Third concentric circle 330 uses size differences of diamond-shaped blobs to express 12-bit information “0100 1101 0111” starting from the vertical (12 o'clock) direction. Fourth concentric circle 340 is configured to express 16 bits of information using circular blobs, but in the example of FIG. 3, it does not express separate information and is being utilized for angle synchronization purposes.

It is obvious that embodiments of the present invention are not limited to the example shown in FIG. 3. For example, it can be understood that various modified implementations are possible in terms of using other figures or polygons, using multi-level symbols such as ternary instead of binary (e.g., expressing 0, 1, or 2 by dividing blob sizes into three levels), unequal spacing of blob placement, and whether concentric angles match between concentric circles. These various implementation methods may be combined or modified within the scope of the technical concept of the present invention.

For instance, according to various modified embodiments of the present invention, blob shapes may be modified even more variously according to information expression methods. For example, one blob may include a predetermined pattern within it, and such patterns may include cross shapes, star shapes, bar shapes at specific angles, or geometric patterns. Also, blobs may have hollow shapes, in which case information can be expressed by changing the thickness of borders or the size of internal spaces. Furthermore, blobs may have asymmetric shapes, in which case additional information can be expressed using the directionality of blobs. For example, in the case of triangular blobs, different values may be represented according to the direction of their vertices. Of course, it is obvious that the technical concept of the present invention can be equivalently implemented without being limited to the various modified embodiments described above.

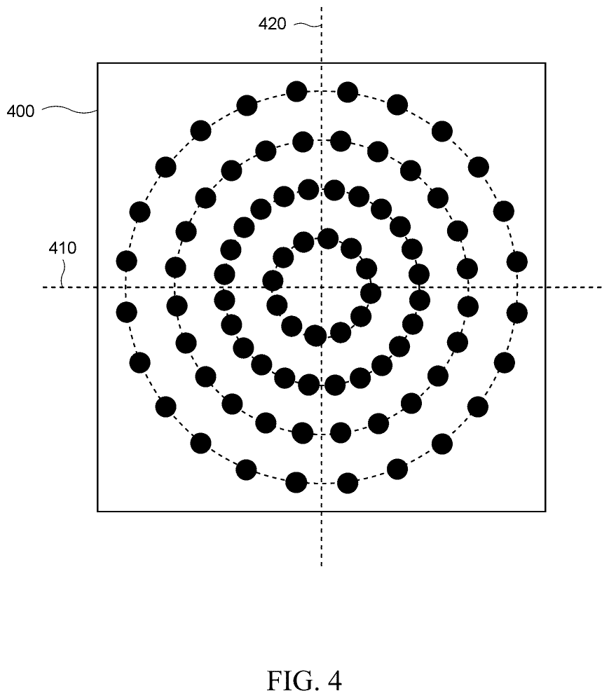

FIG. 4 is an exemplary diagram illustrating blob placement positions in a concentric pattern according to one embodiment of the present invention. The example in FIG. 4 shows how blobs of concentric pattern 400 are arranged based on horizontal axis 410 and vertical axis 420. According to embodiments, the blobs may be arranged at a density suitable for watermark identification. In the example of FIG. 4, blobs capable of recording 12, 24, 24, and 24 bits of information from the inner concentric circle are provided.

According to one embodiment of the present invention, concentric pattern 400 may be configured such that blobs are arranged avoiding horizontal axis 410 and vertical axis 420, which considers characteristics in the frequency domain. Specifically, the concentric pattern is intended to be processed in the frequency domain, and in the case of typical digital media, when converted to the frequency domain, original information of the digital media, such as image contours or gradual color changes, generally exhibits high information content in low-frequency regions. Particularly in the case of frequency domain transforms including Fourier transform, information in low-frequency regions tends to converge to areas close to the central horizontal and vertical lines. Therefore, when at least part of the concentric pattern is placed on horizontal axis 410 and vertical axis 420 corresponding to low-frequency regions, image information originally possessed by the digital media before watermark embedding may already generate significant information values in those regions, potentially interfering with identification in the detection stage after embedding the watermark in the digital media. Therefore, watermark detection accuracy can be improved by arranging blobs while avoiding such low-frequency regions.

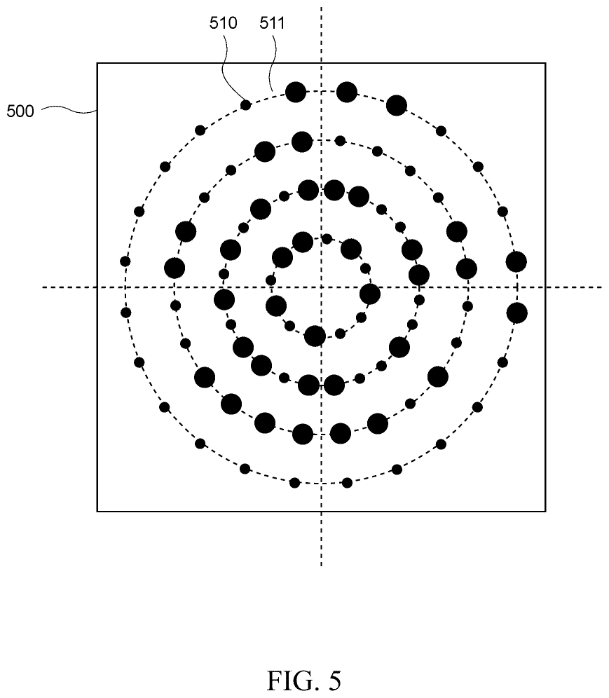

FIG. 5 is an exemplary diagram illustrating a method for expressing watermark messages using concentric patterns according to one embodiment of the present invention. Based on the blob placement positions shown in FIG. 4, Example 500 of FIG. 5 shows a method of expressing binary information using circular symbols of different sizes and positions. According to the example shown in FIG. 5, two sizes of circular symbols are arranged at each blob position. In this example, small circular symbol 510 represents binary ‘0’, and large circular symbol 511 may be interpreted as representing binary ‘1’. These symbols may be arranged along each concentric circle to constitute a watermark message.

According to one embodiment of the present invention, the concentric pattern may be read sequentially from inside to outside, each in a clockwise direction based on the vertical (12 o'clock) direction. For instance, in the example shown in FIG. 5, the innermost first concentric circle includes 12 bits of information, representing binary codes “010/100/101/011” for each quadrant, and the second concentric circle includes 24 bits of information, representing binary codes “110011/001001/101101/010101”. Similarly, the third concentric circle represents binary codes “000011/001011/111100/110011”, and the outermost fourth concentric circle may be interpreted as representing binary codes “110001/100000/000000/000001”. In other words, the concentric pattern shown in FIG. 5 may be interpreted as being configured to express a total of 84 bits of information.

According to one embodiment of the present invention, the information expressed by the concentric pattern may be configured by being divided into actual message information and error correction code (ECC). The encoding method of the error correction code is not limited in the present invention, and for example, various error correction code generation methods conventionally known in the art or newly provided, including parity bit, Hamming code, BCH code (Bose-Chaudhuri-Hocquenghem Code), Reed-Solomon code, LDPC code (low density parity check code), turbo code, convolutional code, cyclic redundancy check (CRC), may be applied according to the implementation aspects and purposes of the present invention. Referring to FIG. 5, in the example of FIGS. 5, 60 bits from the innermost first concentric circle to the third concentric circle represent actual message information, and 24 bits of the outermost fourth concentric circle represent Hamming code-based error correction codes for the corresponding message information. Of course, as described above, various other error correction code application methods may be used in addition to the method exemplified in FIG. 5.

According to one embodiment of the present invention, it may be advantageous for error correction codes to be placed on the outermost concentric circle as in the example of FIG. 5. In information representation in the frequency domain, high-frequency regions have characteristics of being relatively more susceptible to corruption compared to low-frequency regions. This is because when digital media undergoes processing such as compression, scaling, or noise removal, high-frequency components tend to be preferentially removed or lost. Such processing may particularly be applied as attacks intended to damage digital watermarks, so watermarks need to be as robust as possible against such processing. Therefore, according to one embodiment of the present invention, by placing error correction codes in outer concentric circles, i.e., high-frequency regions, the stability of actual message information can be ensured. Even if error correction codes in high-frequency regions are partially corrupted, actual messages located in inner concentric circles in low-frequency regions are likely to be stably preserved, and error correction codes having only loss recovery functions may remain as targets for selective identification.

Of course, the reverse implementation method would also be possible. For instance, by inserting error correction codes in the innermost concentric circle, arrangements may be made so that values can be back-calculated even if outer concentric circles are partially lost. Also, according to various modified embodiments of the present invention, it is obvious that various applications are possible, such as placing other messages of lower importance inside or outside instead of the error correction codes, or arranging information from inside to outside with multi-level differences in importance.

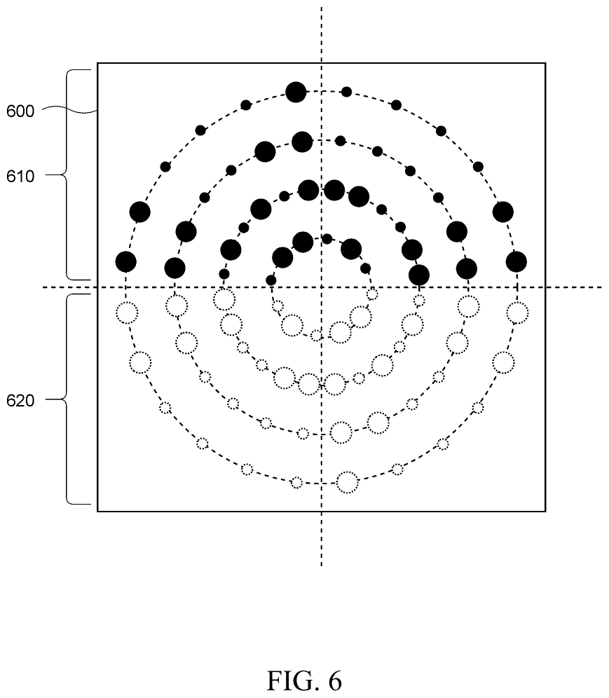

According to embodiments of the present invention, the concentric pattern may be formed limited to regions of 180 degrees or less in rotation angle. FIG. 6 is an exemplary diagram of symmetry limitation in concentric patterns according to one embodiment of the present invention. In example 600 of FIG. 6, the concentric pattern is divided into upper half region 610 and lower half region 620, showing that blobs are arranged only in upper half region 610. This configuration considers characteristics of frequency transform and inverse transform methods. For example, Fourier transform may exhibit frequency symmetry, while cosine transform may not. When using transforms that exhibit frequency symmetry such as Fourier transform, frequency signals may exhibit characteristics of being detected symmetrically based on the center point. Therefore, by forming patterns limited to regions of 180 degrees or less, for example upper half region 610, pattern overlap due to frequency symmetry can be prevented and detection effectiveness can be improved. Lower half region 620 shown with dotted lines in FIG. 6 conceptually represents regions where blobs are not actually placed but where patterns from upper half region 610 are symmetrically projected during frequency transformation. According to such configuration, the number of bits when recording messages at the same density may be reduced (for example, the example in FIG. 6 has the same density as the example in FIG. 5 but the amount of information is limited to 42 bits), but information identification in the frequency domain becomes easier and watermark detection accuracy can be improved.

According to embodiments of the present invention, the concentric pattern may be formed limited to regions of 180 degrees or less in rotation angle. FIG. 6 is an exemplary diagram of symmetry limitation in concentric patterns according to one embodiment of the present invention. In example 600 of FIG. 6, the concentric pattern is divided into upper half region 610 and lower half region 620, showing that blobs are arranged only in upper half region 610. This configuration considers characteristics of frequency transform and inverse transform methods. For example, Fourier transform may exhibit frequency symmetry, while cosine transform may not. When using transforms that exhibit frequency symmetry such as Fourier transform, frequency signals may exhibit characteristics of being detected symmetrically based on the center point. Therefore, by forming patterns limited to regions of 180 degrees or less, for example upper half region 610, pattern overlap due to frequency symmetry can be prevented and detection effectiveness can be improved. Lower half region 620 shown with dotted lines in FIG. 6 conceptually represents regions where blobs are not actually placed but where patterns from upper half region 610 are symmetrically projected during frequency transformation. According to such configuration, the number of bits when recording messages at the same density may be reduced (for example, the example in FIG. 6 has the same density as the example in FIG. 5 but the amount of information is limited to 42 bits), but information identification in the frequency domain becomes easier and watermark detection accuracy can be improved.

The embodiments of concentric pattern formation methods shown with reference to FIGS. 2 through 6 do not limit the implementation forms of the present invention, and it should be understood that the embodiments listed in the present invention may be further applied or two or more may be mutually combined for implementation.

The step of generating first frequency domain data including the concentric pattern (S140) may mean the step of obtaining the first frequency domain data by generating information about the concentric pattern as frequency domain information. In one embodiment of the present invention, information about the concentric pattern may be used alone as frequency domain information. In another embodiment of the present invention, information about the concentric pattern may be used as frequency domain information by being merged with other information.

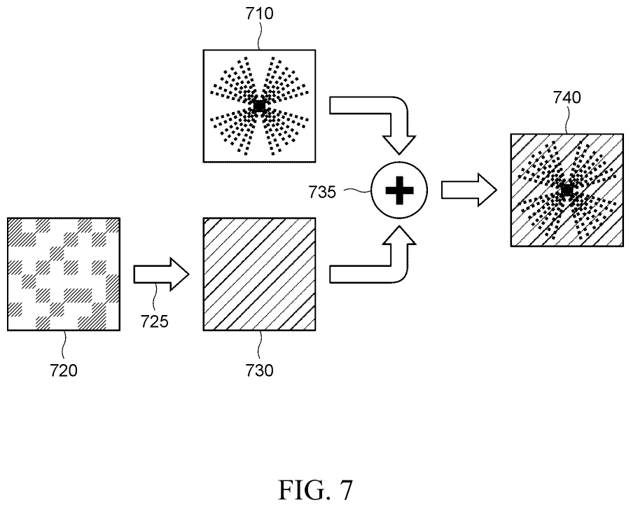

FIG. 7 is a conceptual diagram of an implementation method for merging base patterns and concentric patterns in the frequency domain according to one embodiment of the present invention. Note that the procedure shown in FIG. 7 may not be an essential process in implementing the present invention. Referring to FIG. 7, according to one embodiment of the present invention, for purposes such as reducing the visibility of concentric pattern 710 when embedded as a watermark, the concentric pattern may be configured to form insertion pattern 740 by merging 735 with information 730 obtained by frequency domain transforming 725 base pattern 720.

The base pattern may be a random pattern generated by random noise generation such as white noise, brown noise, and/or Gaussian noise. However, in implementing the present invention, the base pattern need not necessarily be random, and even if the base pattern is generated according to predetermined rules or includes other identifiable information, there is no impediment to implementing the present invention. Also, the reason for using the base pattern need not be to reduce watermark visibility. According to embodiments, the base pattern may include auxiliary information for watermark identification. For example, the base pattern may include watermark version information, reference values for adjusting watermark embedding strength, or synchronization information for watermark detection. Also, according to embodiments, the base pattern may include second watermark information, and in this case may be used to express independent watermark information different from the concentric pattern. In addition, any information that has reason to be utilized by being synthesized with the concentric pattern in the form of the base pattern may be used as the base pattern.

For frequency domain transformation 725, frequency domain information transformation methods conventionally known in the art may be commonly used. For example, any one of various frequency domain transformation methods including Fourier transform, cosine transform, sine transform, Hadamard transform, and wavelet transform may be adopted as needed. In this specification, Fourier transform is used as the basis for explanation for easy understanding, but it is obvious that this method of explanation does not constrain the implementation aspects of the present invention.

The step of embedding a watermark by merging the first frequency domain data with the digital media (S150) may mean the step of actually embedding a watermark by merging the first frequency domain data including the concentric pattern with the original digital media.

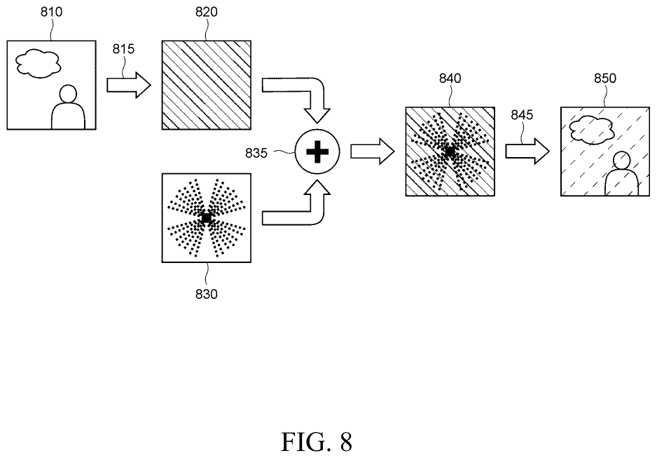

FIG. 8 is a conceptual diagram of a watermark embedding method in the frequency domain according to one embodiment of the present invention. In one embodiment of the present invention, as a method for embedding the watermark, digital media 810 is first frequency transformed 815 to obtain second frequency domain data 820, first frequency domain data 830 is merged 835 with second frequency domain data 820 to generate third frequency domain data 840, and third frequency domain data 840 is inverse transformed 845 to obtain watermarked digital image 850.

The method of frequency transforming 815 digital media 810 may commonly use frequency domain information transformation methods conventionally known in the art, as shown with reference to FIG. 7. For example, any one of various frequency domain transformation methods including Fourier transform, cosine transform, sine transform, Hadamard transform, and wavelet transform may be adopted as needed for transformation 815.

First frequency domain data 830 may be regarded as any frequency domain data including frequency domain data of the concentric pattern. That is, first frequency domain data 830 may include only the concentric pattern, or may be data in which a base pattern and concentric pattern are merged.

According to one embodiment of the present invention, the previously described procedure of FIG. 7 may be optionally omitted so that first frequency domain data 830 is configured to include only the concentric pattern. When the concentric pattern is used alone as first frequency domain data 830 in this manner, there is an advantage that the watermark embedding and detection process is simplified by omitting the merging process with the base pattern. Also, since there is no interference by the base pattern, pure frequency characteristics of watermark information are preserved, which can improve watermark detection accuracy.

Meanwhile, according to another embodiment of the present invention, the previously described optional procedure of FIG. 7 may be executed to add information of base pattern 720 to first frequency domain data 830. In this case, the method used when transforming 725 base pattern 720 and the frequency domain transformation method when transforming 815 digital media 810 may be the same or different from each other. Either is one of various implementation aspects of the present invention and belongs within the technical concept of the present invention.

Referring again to FIG. 8, for merging 835, computational processes including at least one operation among summation, multiplication, and normalization of the two data may be applied. According to one embodiment of the present invention, as one embodiment of the merging 835 process, weighted summation may be performed on each frequency component of the first frequency domain data and second frequency domain data. For example, when α is a weight between 0 and 1, third frequency domain data may be generated in the form of ‘α×(first frequency domain data)+(1−α)×(second frequency domain data)’. Alternatively, methods such as selecting maximum values for each frequency component of the two frequency domain data, or applying different weights to each frequency component may be used. In addition, it is obvious that various methods conventionally known in the art or newly proposed that can be used for merging information in the frequency domain may be commonly applied.

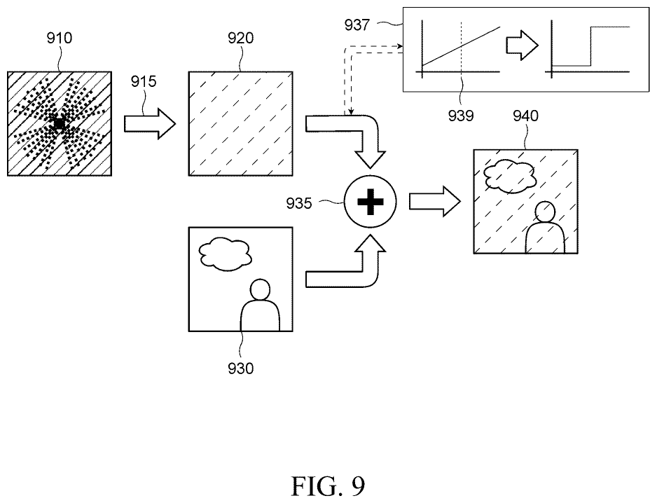

FIG. 9 is a conceptual diagram of another watermark embedding method in the frequency domain according to another embodiment of the present invention. In one embodiment of the present invention, as a method for embedding the watermark, first frequency domain data 910 is first inverse transformed 915 to generate watermark data 920, and watermark data 920 is merged 935 with digital media 930 to obtain watermarked digital image 940. At this time, computational processes including at least one operation among summation, multiplication, and normalization of the two data may be applied to merging 935, and it is obvious that various methods conventionally known in the art or newly proposed that can be used for merging information corresponding to digital media (e.g., images) may be commonly applied. Also, merging methods conventionally known in the art or newly proposed for embedding visible or invisible watermarks in digital media using pattern overlay methods may also be applied.

In one embodiment of the present invention, watermark data 920 may be binarized 937 prior to merging 935. Watermark data 920 may, depending on implementation methods, be generated as information having multiple value levels, and for example, may be generated in the form of a grayscale image. The grayscale image may be modulated into a binary pattern consisting of 1s and 0s based on a certain threshold 939 as needed and binarized 937. The binarization may be applied for computational convenience and visibility reduction when watermark data 920 is embedded as a pattern overlay. Even when embedded through binarization, changes according to high and low values are preserved, so information embedded in the frequency domain is expected to be preserved.

According to one embodiment of the present invention, the binarization may be performed in various ways for information compression and normalization in the spatial domain. Specifically, the threshold may use values determined through analysis of overall data average, median, or histogram analysis, or may be dynamically determined according to image characteristics using locally adaptive thresholds. The binarization may also be performed using dithering techniques including error diffusion methods, in which case information loss during the binarization process can be minimized while maintaining visual quality.

According to one embodiment of the present invention, the step of embedding the watermark (S150) may be performed independently or in conjunction for multiple channels. For example, in RGB color space, watermarks having different weights may be embedded in R and G channels, and in YUV or YCbCr color space, main watermarks may be embedded in the luminance (Y) channel and auxiliary information may be embedded in chrominance channels. Also, in CMYK color space, it is possible to intensively embed watermarks in the Y (Yellow) channel or distribute watermarks across multiple channels. When watermark embedding operates on multiple channels in this manner, the first frequency domain data may be generated identically for all channels or may be generated differently, and when generated differently, it is obvious that at least some or all of the entire steps from watermark message generation (S120) to watermark embedding (S150) may be performed multiple times in parallel, sequentially, repeatedly, and/or independently for each different first frequency domain data. Also, it can be seen that watermark methods when embedded for each of the channels may be the same or different without impeding implementation of the present invention.

According to one embodiment of the present invention, in the step of embedding the watermark (S150), watermark-related information, i.e., at least one of the base pattern, the concentric pattern, the first frequency domain data, or the watermark data, may be repeatedly embedded multiple times. For example, referring again to FIG. 7, first frequency domain data 740 may be generated by including a single concentric pattern 710 in a pattern where one base pattern 720 is repeatedly continuous, or by including repeatedly continuous concentric patterns 710 for a single base pattern 720, or by including repeatedly continuous concentric patterns 710 in a pattern where one base pattern 720 is repeatedly continuous. Similarly, referring again to FIG. 8, first frequency domain data 830 may be repeatedly continuous and merged 835 with second frequency domain data 820. Similarly, referring again to FIG. 9, watermark data 920 may be repeatedly continuous and merged 935 with digital media 930.

According to one embodiment of the present invention, repetitive embedding of the watermark-related information may include the following embodiments. First, identical watermark data may be repeatedly embedded in different regions of digital media, where each embedding region may overlap or be separated from each other. Also, different watermark data may be embedded in different regions of digital media, which can be utilized for embedding multiple independent messages as watermarks. And identical watermark data may be repeatedly embedded with different weights, which can be utilized to improve watermark detection performance. When repeatedly embedding watermark-related information in this manner, the binarization 937 process shown in FIG. 9 may be applied with even higher importance, which may serve the purpose of suppressing the prominence of visual boundaries between regions due to different frequency components being embedded in each region.

The step of outputting the watermarked digital media (S160) may mean the step of providing the watermarked digital media to other recording media, devices, modules, functional units, or systems. In one embodiment of the present invention, the outputting step (S160) may be configured to transmit the watermarked digital media to specific viewing devices using transmission functions for communication networks. In another embodiment of the present invention, the outputting step (S160) may be configured to record the watermarked digital media on the recording media through computing devices including recording functions for electronic recording media. In yet another embodiment of the present invention, the outputting step (S160) may be configured to be directly connected to digital media viewing devices to display the watermarked digital media to users.

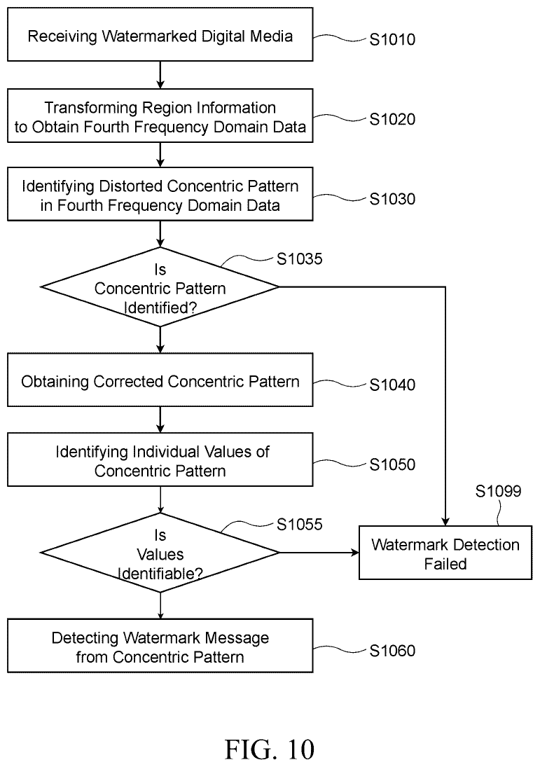

FIG. 10 is a flowchart illustrating a method for detecting a digital watermark from digital media according to one embodiment of the present invention. Referring to FIG. 10, the method according to one embodiment of the present invention may include: receiving watermarked digital media (S1010); frequency transforming the watermarked digital media to obtain fourth frequency domain data (S1020); identifying a distorted concentric pattern in the fourth frequency domain data (S1030); determining whether the concentric pattern is identified (S1035); obtaining a corrected concentric pattern through distortion correction of the concentric pattern (S1040); identifying individual values of the corrected concentric pattern (S1050); determining whether the values can be identified (S1055); and detecting a watermark message from the concentric pattern (S1060).

The step of receiving watermarked digital media (S1010) may be configured to receive watermarked digital media via a digital communication network, or read watermarked digital media stored on fixed or removable digital recording media. It is obvious that various other implementation methods for inputting watermarked digital media information can be applied.

According to a preferred embodiment of the present invention, the watermarked digital media may be a two-dimensional image, and the two-dimensional image case will be used as a representative example for describing the present invention in this specification. However, those skilled in the art will understand that the present invention applicable to two-dimensional images can also be applied to any type of watermarked digital media information implemented by video (implemented as a combination of multiple still images), audio, three-dimensional images, holograms, and other digital signals, and such modified embodiments should also be considered as included in the present invention disclosed through this specification.

According to one embodiment of the present invention, only a portion of the watermarked digital media may be processed as a watermark embedding target. For example, when the digital media is an image, only some spatially divided regions of the image may be processed as watermark embedding targets. As another example, when the digital media is an image with color information, at least one piece of partial information representing the color information and/or at least one piece of channel information expressing the color information may be partially processed. Also, according to embodiments, multiple color channels may be selected as processing targets, and in such cases, each channel may be utilized for watermark detection with different weights. Various methods conventionally known in the art or newly provided may be used to separate such partial regions or channels, and the details of such variations are not limited in the present invention. Also, according to embodiments, the digital media may be converted for the partial processing.

Related application implementation methods can be understood as processes of selecting extraction target channels for watermark extraction in the same or similar manner as selecting watermark embedding target channels in the previously described watermark embedding method. At this time, it can be seen that watermark methods embedded for each of the channels may be the same or different without impeding implementation of the present invention.

According to one embodiment of the present invention, for example, in a digital media image using RGB (red, green, blue) color representation, only the R (red) channel may be the processing target for watermark information embedding. Also, according to embodiments, multiple color channels may be selected as processing targets, and in such cases, each channel may be utilized for watermark embedding with different weights. For example, when using the G (green) channel together with the R channel, watermarks may be embedded in both the R channel and G channel, but with different weights.

The present invention may be applied to digital media images composed of various channel information according to embodiments. For example, it is obvious that the invention can be equally applied when using HSB (hue, saturation, brightness) color representation, when using CMYK (cyan, magenta, yellow, black) color representation, when using luminance and chrominance-based color representations such as YUV/YCbCr, and when channel information is configured by various other color representations not mentioned above. According to embodiments, even when channels containing additional information such as transparency, alpha, and/or depth are added to any color representation, the embodiment can be applied including all such additional channels. For example, to facilitate watermark embedding processing based on luminance channel information, the digital media may be converted from RGB color representation to color representation methods having luminance channels such as HSB or YUV. The details of such color conversion methods are not limited in the present invention.

The step of frequency transforming the region information to obtain fourth frequency domain data (S1020) may mean the process of converting the watermarked digital media into frequency domain information and extracting frequency domain information containing the watermark from the frequency domain information. According to one embodiment of the present invention, various frequency domain transformation methods such as Fourier transform, cosine transform, and wavelet transform may be used for transformation into frequency domain information, and it may be preferable to use the same transformation method as used during watermark embedding. That is, it can be considered as the reverse order of the watermark embedding steps described above in this specification.

According to one embodiment of the present invention, the frequency transformation step may be performed independently or in conjunction for multiple channels. For example, when watermarks are embedded in R and G channels with different weights in RGB color space, frequency transformation may be performed on each of those channels during detection and fourth frequency domain data may be obtained considering channel-specific weights. For instance, when the R channel weight is 0.7 and the G channel weight is 0.3, detected frequency domain data may also be combined at the same ratio to generate final fourth frequency domain data. As another example, when main watermarks are embedded in the luminance (Y) channel in YUV color space, the luminance channel may be preferentially processed during detection.

According to another embodiment of the present invention, the channel-specific weights may be dynamically adjusted by evaluating the reliability of frequency transformation results for each channel. For example, when image quality of a specific channel is degraded or noise is severe, the weight of that channel may be lowered and the weight of relatively good channels may be increased. For this purpose, various indicators including Signal-to-Noise Ratio (SNR) for each channel may be utilized.

According to one embodiment of the present invention, preprocessing considering the size or shape of regions may be performed during frequency transformation. For example, when the region size is not a power of 2, padding may be added, or windowing functions may be applied to reduce boundary effects. Also, preprocessing such as normalizing the average value of regions or adjusting contrast may be performed before frequency transformation to improve transformation accuracy.

According to one embodiment of the present invention, preprocessing considering channel-specific weights may also be performed during color representation conversion processes. For example, when detecting RGB color space watermarks in YUV color space, weights applied to each RGB channel may be appropriately reflected in the YUV conversion process. This can be particularly utilized to optimize information distribution between luminance (Y) and chrominance (UV) channels from a watermark detection perspective.

According to one embodiment of the present invention, when multiple spatial watermark detection target regions exist, more robust frequency domain data may be obtained by combining frequency transformation results for each region. At this time, frequency transformation results of each region may be combined in various ways including weighted averaging, maximum value selection, median selection, or correlation calculation, and combination methods may be selected considering inter-region correlations or reliability.

According to another embodiment of the present invention, the step of obtaining fourth frequency domain data (S1020) may be performed by generating at least one fifth frequency domain data by frequency transforming the region information, and overlapping the at least one fifth frequency domain data to generate the fourth frequency domain data. At this time, each fifth frequency domain data is expected to have different background frequency values but share concentric pattern information in the same frequency domain, so by overlapping them, frequency components corresponding to the concentric pattern can be further amplified and derived in a form that facilitates extraction.

According to one embodiment of the present invention, the step of identifying the concentric pattern (S1030) may mean the step of identifying a concentric pattern including geometric distortion in the fourth frequency domain data. In the step of identifying the concentric pattern (S1030), various manipulations may have been applied to the watermarked digital media. The present invention presupposes that watermark patterns will always have a predetermined concentric pattern form, and may be configured to restore the distorted state of the concentric pattern by extracting the outline of the concentric pattern from the extracted frequency domain data. Therefore, according to one embodiment of the present invention, the step of identifying a distorted concentric pattern in the fourth frequency domain data (S1030) may include the process of identifying concentric patterns by detecting clusters of points having certain regularity in the frequency domain. Particularly, according to one embodiment of the present invention, a method of identifying effective points forming concentric patterns among points appearing in the frequency domain using outlier detection algorithms may be used. These effective points may potentially include or not include concentric patterns, hereinafter referred to as “concentric pattern regions.”

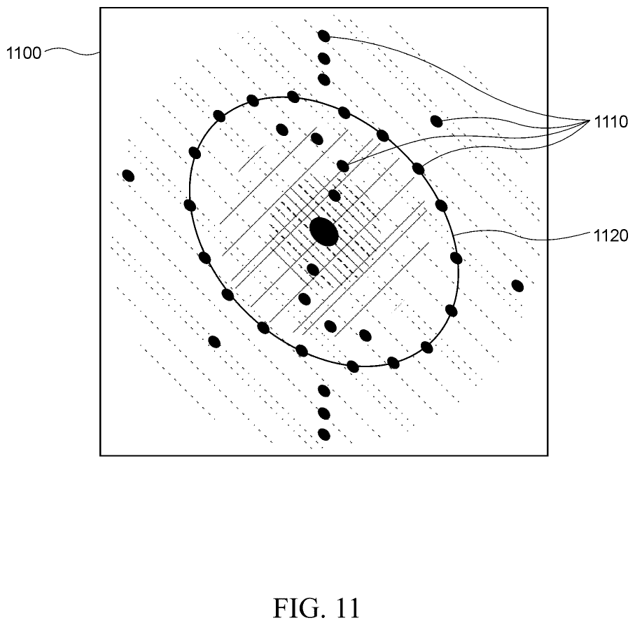

FIG. 11 is a conceptual diagram illustrating a process for identifying concentric pattern regions through outlier detection according to one embodiment of the present invention. Referring to FIG. 11, among multiple peak points 1110 appearing in fourth frequency domain data 1100, points expected to constitute concentric patterns, i.e., concentric pattern regions, can be identified, and based on the identified points, orbits 1120 estimated as outlines of concentric pattern regions can be derived. Fourth frequency domain data 1100 is derived from watermarked digital media, and among peak points 1110 observed from data 1100, not only points constituting concentric patterns but also points due to original signals or noise of digital media may exist together. Also, each point constituting the concentric pattern may be distributed throughout the frequency domain. Therefore, using outlier detection algorithms, points on concentric pattern region outline 1120 expected to form concentric patterns can be selectively extracted from peak points 1110 distributed throughout the frequency domain.

According to a preferred embodiment of the present invention, the outlier detection algorithm may identify sets of points forming concentric circles by analyzing geometric relationships between peak points 1110. For example, by analyzing distance and angle relationships between peak points 1110, points located on the same radius can be clustered, and based on this, orbit 1120 of the concentric pattern region can be estimated. The shape of orbit 1120 may be distorted according to geometric transformations applied to the watermarked digital media, and such distortion information can be utilized as a reference for correction in subsequent watermark detection processes.

According to one embodiment of the present invention, the outlier detection and removal algorithm for identifying the concentric pattern region may include at least one of the following detailed steps: 1) clustering based on distances and angles between points, 2) orbit fitting using least square method, 3) statistical outlier removal, 4) geometric consistency verification. Also, according to one embodiment of the present invention, the following techniques may be applied to improve the accuracy of concentric pattern region identification through outlier detection and removal: 1) weight assignment based on point intensity, 2) stepwise pattern detection through hierarchical clustering, 3) effective point selection through local density estimation, 4) adaptive detection through dynamic threshold application. Through such outlier detection processes, concentric pattern regions existing in distorted states due to geometric transformations or noise can be effectively identified, and it is obvious that methods, algorithms, or processing techniques conventionally known in the art or newly provided, in addition to the methods described above, may be used to identify orbit 1120 of the concentric pattern region from fourth frequency domain data 1100.

According to another embodiment of the present invention, the step of extracting the concentric pattern region may include removing low-frequency region data from fourth frequency domain data 1100. In the case of typical digital media, when converted to the frequency domain, high information content is generally concentrated in low-frequency regions, and by removing such low-frequency regions, frequency information corresponding to concentric pattern regions can be extracted more clearly.

According to one embodiment of the present invention, in the step of determining whether the concentric pattern is identified (S1035), it can be verified whether the detected cluster of points, i.e., the concentric pattern region, actually satisfies geometric characteristics as a concentric pattern. For example, when an insufficient number of points are detected, when distance relationships between points do not match expected orbit radii, or when angular distribution of points is irregular, it may be determined that no watermark exists. Therefore, as described above, when a concentric pattern cannot be specified in the concentric pattern region 1120 corresponding to the watermark, it may be determined (S1099) that no watermark exists in the corresponding image, thereby not proceeding with a series of subsequent watermark detection procedures including the step of obtaining a corrected concentric pattern (S1040), which can contribute to improving the speed of watermark detection processes in situations where watermarks must be identified in real-time and/or in large quantities.

The step of obtaining a corrected concentric pattern (S1040) may include the process of analyzing geometric distortion of concentric patterns identified in concentric pattern regions and correcting them to obtain concentric patterns close to their original form. Step S1040 may mean the process of restoring concentric patterns detected in distorted forms such as orbit 1120 in FIG. 11 from fourth frequency domain data 1100 described above to their original forms.

According to one embodiment of the present invention, various geometric corrections may be applied for distortion correction of concentric patterns. For example, rotation correction may be applied to correct overall directional misalignment of concentric patterns. As another example, scaling correction may be applied to correct size changes of distorted concentric patterns, and transformations including proportional and non-proportional scaling may be applied. As another example, shear correction may be applied to correct cases where concentric patterns are tilted to one side. As yet another example, perspective correction may be applied to correct cases where concentric patterns have undergone projection distortion.

According to one embodiment of the present invention, to actually apply distortion correction of concentric patterns, which geometric transformation among the respective geometric transformations should be applied and what specific parameters should be applied for such geometric transformations can be calculated. For example, the center point position of the concentric pattern may be assumed to be the center of detected frequency domain data due to frequency domain characteristics, but if there may be variations, the center point position of the concentric pattern can be estimated through various computational methods including center of gravity derivation, center coordinate calculation through symmetry analysis, and intersection estimation using least square method. As another example, to estimate what size the concentric pattern appeared in the frequency domain, the estimated radius of the concentric pattern can be specified through various estimation methods including analysis of distance distribution of points in each orbit from the center point, major/minor axis ratio calculation of distorted circular orbits through ellipse fitting, and restoration of relative size relationships between orbits through normalization of radius ratios. When such geometric parameters are determined, transformation matrices can be generated by conventionally known geometric methods and applied to fourth frequency domain data 1100. Methods for deriving the transformation matrices may include, for example, procedures such as inverse calculation of affine transform matrices, homography matrix calculation, and optimization of transformation parameters for geometric correction. By transforming the frequency domain data through calculation using the transformation matrices, frequency domain data with concentric pattern shapes restored to circular forms can be obtained, thereby preparing for verification of watermark patterns in the subsequent individual value identification step (S1050) of concentric patterns.

In the step of identifying individual values (S1050), individual values can be identified by analyzing the size, shape, or position of blobs arranged on each orbit in the corrected concentric pattern. According to one embodiment of the present invention, concentric patterns with corrected geometric distortion may still appear in partially distorted forms, but since how concentric patterns will arrange blobs in what form and at which positions corresponds to insertion information known in advance by the watermark detection system, the values of each blob can be interpreted through identification processing based on those positions.

Therefore, according to one embodiment, pattern matching may be performed on regions where blobs are expected to appear. That is, based on concentric pattern insertion information that places at least one blob at a designated position on at least one orbit, it can be confirmed whether frequency domain information recognizable as blobs exists at positions corresponding to the insertion information. The pattern matching may be implemented through any image processing methods that analyze frequency component information of corresponding regions to estimate blob size or shape. Particularly, even when blobs are smeared or spread in specific directions due to geometric distortion, the original size or shape of blobs can be mathematically back-calculated by analyzing intensity distribution of frequency component information within corresponding regions.

According to one embodiment of the present invention, the frequency component intensity distribution analysis may be performed by methods such as integral value calculation in local regions, moment analysis of frequency response characteristics, and energy density distribution estimation. Also, when types of shapes that blobs can have are predetermined, the most similar shape can be selected by calculating correlation using frequency response characteristics of the shapes as reference patterns. Also, according to embodiments of the present invention, even when blob shapes or sizes are unclear, values can be estimated by analyzing relative relationships with surrounding blobs. For example, individual blob values can be more accurately identified through relative size comparison with other blobs on the same orbit, shape comparison with blobs on adjacent orbits, or relationship analysis between blobs located at the same angle.

According to one embodiment of the present invention, the step of identifying individual values of the concentric pattern (S1050) may include the process of applying morphology operations to detected blobs to normalize blob shape and size. For example, noise can be removed and blob shapes can be corrected through opening or closing operations combining erosion and dilation operations, which can be particularly effective when blobs are smeared or distorted in the frequency domain.

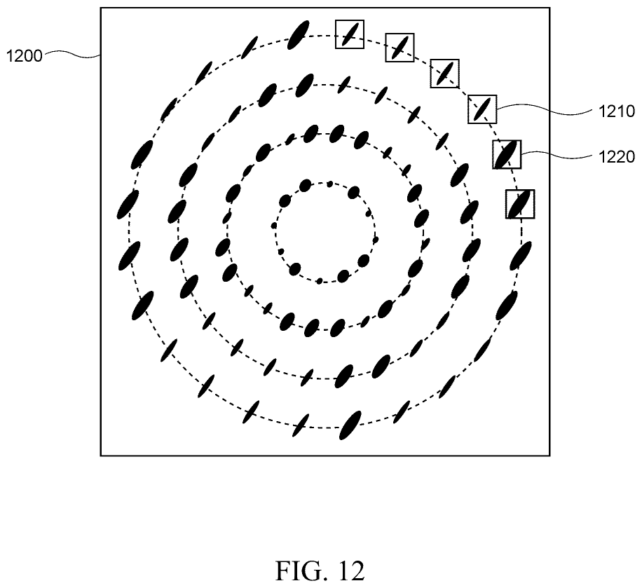

FIG. 12 is an exemplary diagram illustrating a pattern matching process for blob identification in concentric patterns according to one embodiment of the present invention. Referring to FIG. 12, even after geometric distortion correction, each blob of the concentric pattern may not be completely restored to perfect circular form. In the example of FIG. 12, watermark messages were originally configured to be identified through blob sizes at blob positions on each orbit, but as a result of digital image transformation and/or geometric distortion restoration, the example shows results where shapes become severely distorted toward high-frequency regions and blob forms become blurred into elliptical shapes. In such cases, since blob positions on each orbit are known, frequency components can be analyzed limited to hypothetical positions of each blob. Through such position-based local frequency component analysis, small-sized blobs 1210 and large-sized blobs 1220 can be distinguished and identified. The blobs may appear in forms distorted or distorted in specific directions or to specific levels in the frequency domain, but by analyzing frequency component distribution at corresponding positions, the original blob shape and size can be estimated. Various signal processing techniques conventionally known in the art or newly provided may be used for the frequency component analysis, including techniques such as correlation calculation, filtering operations, average value calculation, and distribution calculation.

According to one embodiment of the present invention, watermark identification attempts such as pattern matching may be executed after removing symmetry from the fourth frequency domain data. As described above, due to frequency information characteristics, watermark data may maintain symmetry where it is detected in regions spanning the entire circle during detection even if it was embedded only in regions of semicircle or less during embedding. Such symmetry may be considered in the concentric pattern processing, and may be utilized for purposes such as improving processing speed by performing pattern matching only on half regions with symmetry removed, or improving detection rates by duplicating pattern matching procedures for each semicircle region and then comparing whether identical results are obtained.

Through the individual value identification process described above, it can be determined whether concentric patterns actually contain watermark information, which becomes the basis for subsequent watermark message detection. In the step of determining whether values can be identified (S1055), it can be verified whether sizes or shapes of blobs identified in corrected concentric patterns can be interpreted as watermark patterns. When frequency component intensity does not reach threshold values, when blob distribution significantly differs from expected patterns, or when error correction code verification fails, and in other cases where identification of the watermark values is impossible (S1055), processing may proceed to watermark detection failure (S1099).

If concentric patterns corresponding to watermarks are not detected, it may be determined (S1099) that no watermark exists in the corresponding image, thereby not proceeding with a series of subsequent watermark detection procedures including the step of detecting watermark messages (S1060), which can contribute to improving the speed of watermark detection processes in situations where watermarks must be identified in real-time and/or in large quantities.

Finally, in the step of detecting watermark messages (S1060), identified values can be combined to extract watermark messages, and if necessary, final watermark messages can be obtained through processes such as error correction.

According to one embodiment of the present invention, the step of detecting watermark messages (S1060) may include the step of correcting signal processing errors based on error correction codes included in the watermark messages. The step of correcting errors may include general methods for message error correction, such as separately extracting actual message sections and error correction code sections from watermark messages, verifying integrity of the actual message section data using the error correction codes, and attempting restoration through error correction codes if bit errors have occurred or recognition reliability of specific watermark signals is low. Preferably, it may be implemented symmetrically with the utilization of error correction codes described in the watermark embedding method.

According to one embodiment of the present invention, since high-frequency regions such as outermost orbits have characteristics where frequency components are relatively susceptible to corruption, restoration procedures considering this may be performed even when parts of error correction codes are lost or distorted. For example, when error correction codes exist on the outermost orbit and only some of them are successfully detected, limited error verification and restoration may be attempted using only the detected partial error correction codes. As another example, when error correction codes exist on the innermost orbit and only some messages from the outermost orbit are successfully detected, the error correction codes may be used to restore parts that failed detection. Also, error correction codes obtained from multiple detection regions may be used complementarily to reconstruct more complete forms of error correction codes.

According to yet another embodiment of the present invention, message verification processes using error correction codes may be performed stepwise. First, it can be checked whether basic formats and structures of messages detected from inner orbits are valid, and then detailed verification using error correction codes can be performed. At this time, when messages appearing on at least one orbit are determined to be severely corrupted or distorted, restoration possibility through error correction codes may be evaluated first before attempting restoration. Such stepwise approaches can reduce unnecessary computations and improve detection efficiency.

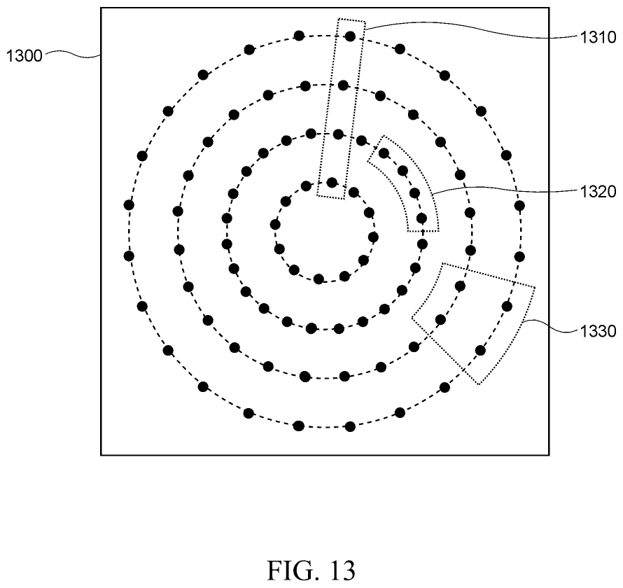

According to one embodiment of the present invention, multiple blobs may be bundled to express one watermark message. FIG. 13 is an exemplary diagram illustrating a method for expressing watermark messages through grouping of blobs according to one embodiment of the present invention. As shown in FIG. 13, blobs of concentric patterns can be grouped in various ways to express messages.

For example, first example 1310 shows a method of expressing messages by bundling blobs located at the same angle into one group. In this case, blobs in the same direction constitute one message even if located on different orbits. As another example, second example 1320 shows a method of expressing messages by bundling consecutive blobs on the same orbit into one group. In this case, adjacent blobs on each concentric orbit constitute one message. As yet another example, third example 1330 shows a method of expressing messages by bundling adjacent blobs into one group considering both angles and orbits. In this case, spatially adjacent blobs constitute one message even if located at different angles and orbits.

Each grouping method may be selectively applied according to watermark purposes or digital media characteristics. For example, angle-based grouping 1310 may have characteristics robust against rotation transformations, orbit-based grouping 1320 may have characteristics robust against scaling transformations, and adjacent blob grouping 1330 may have characteristics more robust against local geometric transformations.

According to one embodiment of the present invention, such blob grouping may be applied in the same manner in watermark embedding and detection processes. During embedding, predetermined messages can be converted into multiple blobs according to the grouping method and arranged, and during detection, original messages can be restored from sets of blobs by applying the same grouping rules.

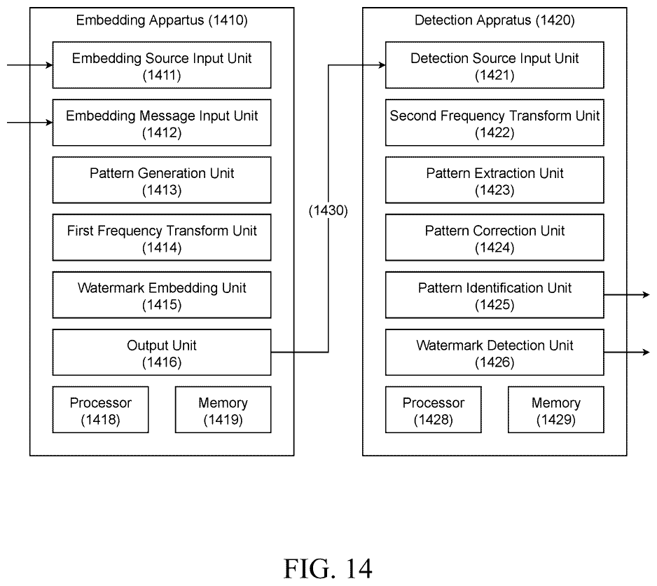

FIG. 14 is a conceptual diagram of a watermark embedding and detection system comprising a digital watermark embedding apparatus and a digital watermark detection apparatus according to one embodiment of the present invention.

While the present invention has been described above with reference to the drawings and specific embodiments, it should be understood that the scope of protection of the present invention is not limited by the aforementioned drawings or embodiments. Those skilled in the art will appreciate that modifications and changes may be made to the present invention without departing from the spirit and scope of the invention as set forth in the claims.

Digital watermark embedding apparatus 1410 according to one embodiment of the present invention may include, to execute the digital watermark embedding method described above in this specification: embedding source input unit 1411 for receiving digital media; embedding message input unit 1412 for receiving watermark messages; pattern generation unit 1413 for generating concentric patterns based on the messages; first frequency transform unit 1414 for generating first frequency domain data including the concentric patterns; watermark embedding unit 1415 for embedding watermarks by merging the frequency domain data with the digital media; and output unit 1416 for outputting the watermarked digital media. Operations of each unit can be easily understood through descriptions of each step of the digital watermark embedding method described above in this specification.

Digital watermark detection apparatus 1420 according to one embodiment of the present invention may include: detection source input unit 1421 for receiving watermarked digital media; second frequency transform unit 1422 for frequency transforming the watermarked digital media to obtain fourth frequency domain data; pattern extraction unit 1423 for extracting concentric pattern regions from the fourth frequency domain data; pattern correction unit 1424 for obtaining corrected concentric patterns through distortion correction of the concentric patterns; pattern identification unit 1425 for identifying concentric patterns including multiple concentric orbits from the corrected concentric patterns; and watermark detection unit 1426 for detecting watermark messages from the concentric patterns. Operations of each unit can be easily understood through descriptions of each step of the digital watermark detection method described above in this specification.

It is obvious that watermarked digital media may be distributed between digital watermark embedding apparatus 1410 and digital watermark detection apparatus 1420 through distribution means 1430. The distribution means may be conventional wired/wireless digital communication networks, hard-wired wiring, or physical recording media including hard disks, optical media, and flash memory.

Each functional unit belonging to digital watermark embedding apparatus 1410 and digital watermark detection apparatus 1420 may be interconnected in various forms such as buses, circuits, or relationships between routines and subroutines to exchange information within each apparatus 1410, 1420. Also, through the interconnections, for the purpose of executing or supporting operations of functional units that mainly require computational performance among the functional units, each apparatus 1410, 1420 may be configured to include processors 1418, 1428 having computational functions and memories 1419, 1429 connected to the processors.

The processors described in this specification may mean one or more general-purpose computers or special-purpose computers, such as processors, controllers, ALUs (arithmetic logic units), digital signal processors, microcomputers, FPAs (field programmable arrays), PLUs (programmable logic units), microprocessors, or any other devices capable of executing and responding to instructions. For convenience of understanding, even when the processor is expressed in singular form, those skilled in the art can understand that the processor may include multiple processing elements and/or multiple types of processing elements. For example, an apparatus according to one embodiment of the present invention may include multiple processors or one processor and one controller as the processor. Also, the processor may be implemented by various processing configurations such as parallel processors or multi-core processors.

The processor may be configured to execute an operating system (OS) and one or more software programs executed on the operating system. Also, the processor may access, store, manipulate, process, and generate data in response to execution of the software.

The software may include computer programs, code, instructions, or combinations of one or more thereof, and may control the processor to operate as desired, and may be configured to give instructions to the processor independently or collectively. The software may be permanently or temporarily embodied in any type of machine, component, physical device, virtual equipment, computer storage medium or device, or transmitted signal wave to be interpreted by the processor or to provide instructions or data to the processor. The software may be distributed over networked computer systems and stored or executed in a distributed manner.

The software may also be implemented in the form of program instructions executable through various computer means and recorded or stored in the memory. The memory may be a computer-readable recording medium, and program instructions, data files, data structures, etc., may be recorded on the computer-readable recording medium alone or in combination. Program instructions stored in the memory may be based on instruction systems specially designed and configured for embodiments of the present invention, or may follow instruction systems known and available to those skilled in computer software, such as instruction systems exemplified by Assembly, C, C++, Java, Python languages, etc. The instruction systems and program instructions thereby should be understood to include not only machine code created by compilers but also high-level language code that can be executed by apparatuses according to embodiments of the present invention and/or the processors using interpreters, etc.

Computer-readable recording media constituting apparatuses according to embodiments of the present invention, including the memory described in this specification, may include temporary or volatile recording media maintained only while the processor operates, such as processor cache, RAM, and flash memory, or may include recording media that are relatively non-volatile or capable of long-term recording, such as magnetic media like hard disks, floppy disks, and magnetic tapes, optical media like CD-ROMs and DVDs, magneto-optical media like floptical disks, or solid state memory, or may include read-only recording media such as ROM disposed on hardware. Furthermore, hard-wired structures configured to perform operations equivalent to series of program instructions by circuit wiring may also be considered as having the operations for performing each step recorded by connection and arrangement of the hardware components, so it is obvious to those skilled in the art that the connection and arrangement methods are equivalent to the memory.

The embodiments described above for the processor and memory are not mutually exclusive and may be selected or combined for implementation as needed. For example, one hardware device may be configured to operate as a module composed of one or more software for performing operations of embodiments of the present invention, and vice versa. As another example, in this specification, all or part of operations assigned to any functional unit may be implemented by one or more software stored in apparatuses according to embodiments of the present invention (preferably, in any recording medium belonging to the category of the memory) and configured to be executed by the processor, and in such cases, such functional units may be implemented as functional units “included” in the processor.

The above description of the present invention with reference to drawings and embodiments does not mean that the protection scope of the present invention is limited by the presented drawings or embodiments as already described above, and those skilled in the art can understand that the present invention may be variously modified and changed within the scope not departing from the spirit and scope of the present invention described in the claims of the present invention patent.

What is claimed is:

1. A method for embedding a digital watermark into digital media by an information processing apparatus, the method comprising:
receiving digital media;
generating a watermark message;
generating a concentric pattern including multiple concentric orbits based on the watermark message, wherein the concentric pattern is generated by placing at least one blob on each of the concentric orbits and varying a size of at least one of the blobs in correspondence with symbols constituting the watermark message;
generating first frequency domain data including the concentric pattern;
embedding a watermark by merging the first frequency domain data with the digital media; and
outputting, by the information processing apparatus, the digital media having the watermark embedded therein.

2. The method of claim 1, wherein the step of generating the concentric pattern comprises:
configuring the concentric pattern by varying at least one characteristic among size and shape for at least one of the blobs included in the concentric pattern, in correspondence with symbols constituting the watermark message.

3. The method of claim 1, wherein the step of generating the concentric pattern comprises configuring the concentric pattern by associating multiple blobs included in the concentric pattern with each symbol constituting the watermark message.

4. The method of claim 1, wherein the concentric pattern includes error correction codes.

5. The method of claim 1, wherein the concentric pattern is generated while avoiding low-frequency regions in the frequency domain.

6. The method of claim 1, wherein the step of embedding the watermark comprises:
converting the digital media into second frequency domain data;
merging the first frequency domain data with the second frequency domain data to generate third frequency domain data; and
inverse transforming the third frequency domain data.

7. The method of claim 1, wherein the step of embedding the watermark is performed limited to at least one channel among multiple channels when the digital media includes multiple channels.

8. The method of claim 7, wherein the step of embedding the watermark is performed on multiple channels, with weights related to watermark embedding applied between the multiple channels.

9. A method for detecting a digital watermark from digital media by an information processing apparatus, the method comprising:
receiving watermarked digital media;
frequency transforming the watermarked digital media to obtain fourth frequency domain data;
extracting a concentric pattern region from the fourth frequency domain data, wherein the concentric pattern includes at least one blob on each of the concentric orbits;
correcting geometric distortion of the concentric pattern region;
detecting presence of a concentric pattern including multiple concentric orbits in the concentric pattern region; and
when the concentric pattern is detected, recognizing at least one symbol constituting a watermark message based on a size represented by at least one of the blobs included in the concentric pattern, and detecting a watermark message from the concentric pattern based on the symbols.

10. The method of claim 9, wherein the step of extracting the concentric pattern region includes removing low-frequency region data from the fourth frequency domain data.

11. The method of claim 9, wherein the step of correcting geometric distortion comprises:
applying at least one geometric correction among: correction of scaling distortion based on radius size of the concentric pattern; correction of translation distortion based on center point position of the concentric pattern; and correction of skew distortion based on orbit shape of the concentric pattern.

12. The method of claim 9, further comprising:
designating multiple detection target zones from the watermarked digital media,
wherein the step of obtaining the fourth frequency domain data comprises:
performing frequency transformation on each of the multiple detection target zones to generate multiple fifth frequency domain data; and
overlapping the multiple fifth frequency domain data to generate the fourth frequency domain data.

13. The method of claim 9, wherein the step of detecting the watermark message from the concentric pattern comprises:
detecting error correction codes from the concentric pattern; and
correcting errors in the watermark message using the error correction codes.

14. The method of claim 9, wherein the step of detecting the watermark message comprises:
recognizing symbols constituting the watermark message according to at least one characteristic among size and shape represented by at least one blob included in the concentric pattern.

15. The method of claim 9, wherein the step of detecting the watermark message comprises associating multiple blobs included in the concentric pattern with one symbol constituting the watermark message.

16. The method of claim 9, wherein the step of detecting presence of the concentric pattern comprises:
confirming through pattern matching whether frequency domain information recognizable as blobs exists at positions corresponding to insertion information, based on concentric pattern insertion information that places at least one blob at a designated position on at least one orbit.

17. An apparatus for embedding a digital watermark into digital media, the apparatus comprising:
a processor capable of digital signal processing;
a memory electrically connected to the processor and storing a digital watermark embedding algorithm;
an embedding source input module stored in the memory for receiving digital media;
an embedding message input module stored in the memory for receiving a watermark message;
a pattern generation module executed by the processor for generating a concentric pattern including multiple concentric orbits based on the watermark message;
a first frequency transform module executed by the processor for generating first frequency domain data including the concentric pattern;
a watermark embedding module executed by the processor for embedding a watermark by merging the first frequency domain data with the digital media; and
an output module stored in the memory for storing the digital media having the watermark embedded therein,
wherein the pattern generation module is configured to generate the concentric pattern by placing at least one blob on each of the concentric orbits and varying a size of at least one of the blobs in correspondence with symbols constituting the watermark message.

18. An apparatus for detecting a digital watermark from digital media, the apparatus comprising:
a processor capable of digital signal processing;
a memory electrically connected to the processor and storing a digital watermark detection algorithm;
a detection source input module stored in the memory for receiving watermarked digital media;
a second frequency transform module executed by the processor for frequency transforming the watermarked digital media to obtain fourth frequency domain data;
a pattern extraction module executed by the processor for extracting a concentric pattern region from the fourth frequency domain data;
a pattern correction module executed by the processor for correcting geometric distortion of the concentric pattern region;
a pattern identification module executed by the processor for detecting presence of a concentric pattern including multiple concentric orbits in the concentric pattern region;
a watermark detection module executed by the processor for detecting a watermark message from the concentric pattern when the concentric pattern is detected; and
an output module stored in the memory for storing the detected watermark message,
wherein the watermark detection module is configured to recognize at least one symbol constituting the watermark message based on a size represented by at least one blob included in the concentric pattern, and to detect a watermark message from the concentric pattern based on the symbols.
